(19) United States
(12) Patent Application Publication
(10) Pub. No.: US 2026/0014751 A1
(43) Pub. Date: Jan. 15, 2026

(54) Sterile blow molding machine with airlock and method for the operation thereof

(71) Applicant: KRONES AG, Neutraubling (DE)

(72) Inventors: Florian GERNGROSS, Regensburg (DE); Juergen SOELLNER, Beratzhausen (DE); Norbert KINDL, Tegernheim (DE); Florian GELTINGER, Donaustauf (DE); Waldemar SUPPES, Nittendorf (DE); Christian WITTMANN, Hemau (DE); Daniel THEEN, Lappersdorf (DE)

(21) Appl. No.: 18/993,769

(22) PCT Filed: Mar. 28, 2023
(86) PCT No.: PCT/EP2023/057942

§ 371 Date: Jan. 13, 2025

(30) Foreign Application Priority Data
Jul. 12, 2022 (DE) 10 2022 117 355.0

(51) Int. Cl. B29C 49/46; B29C 49/36; B29C 49/42

(52) U.S. Cl. CPC B29C 49/46; B29C 49/36; B29C 49/4238; B29C 49/42405; B29C 2049/4697

(57) ABSTRACT

An apparatus for forming plastics material preforms into plastics material containers has a transport device having a rotatable transport carrier on which a plurality of forming stations is arranged, wherein said forming stations each have blow molding devices within which the plastics material preforms can be formed by application of a flowable medium into the plastics material containers in a clean room within which the plastics material preforms are expanded into the plastics material containers, and ejection device for ejecting plastics material preforms or plastics material containers from the transport path. The ejection device is integrated in the clean room and/or the ejection device is integrated in at least one wall delimiting the clean room.

The present invention relates to an apparatus and a method for forming plastics material preforms into plastics material containers. Such apparatuses and methods have long been known in the prior art. Usually, heated plastics material preforms are expanded into containers using a gas, in particular compressed air.

More recently, there has been an effort to also allow the production of such containers in a sterile manner. This is advantageous for filling certain beverages. In the prior art, the containers were originally first manufactured, for example stretch blow molded, and then sterilized. In recent times, systems have also become known in which the preforms are already sterilized and then formed in a clean room, for example, stretch blow molded.

Problems may arise if, for example, containers have been damaged or get damaged during the blow molding process. Such damaged containers can cause problems in the system after the production or after the production is attempted. For this reason, it is known per se to eject containers out of the transport path of the containers.

In the case of a sterile blow molding process, however, such an ejection is associated with problems, because care must be taken to ensure that the sterility of the blow molding process is not disturbed or interrupted.

The object of the present invention is therefore to improve the operating sequences of such sterile blow molding machines. This is achieved according to the invention by the subject matter of the independent claims. Advantageous embodiments and developments are the subject matter of the dependent claims.

An apparatus according to the invention for forming plastics material preforms into plastics material containers has a transport device, which transports the plastics material preforms to be formed along a predefined transport path. The transport device has a rotatable transport carrier on which a plurality of forming stations is arranged, wherein said forming stations each have blow molding devices within which the plastics material preforms can be formed by application of a flowable and in particular gaseous medium into the plastics material containers and the forming stations each have application devices in order to apply the flowable and in particular gaseous medium to the plastics material preforms.

Furthermore, the apparatus has a clean room within which the plastics material preforms are expanded and/or can be expanded into the plastics material containers.

According to the invention, the apparatus has an ejection device to eject plastics material preforms or plastics material preforms from the transport path, wherein this ejection device is at least partially and particularly preferably completely integrated into the clean room and/or the ejection device is integrated into at least one wall delimiting the clean room.

In this case, integrated is understood to mean that in particular at least one element of the ejection device is located within the clean room or at the clean room boundary and/or the ejection device also delimits this clean room.

The present invention is further directed to an apparatus for forming plastics material preforms into plastics material containers, with a transport device which transports the plastics material preforms to be formed along a predefined transport path, wherein the transport device has a rotatable transport carrier on which a plurality of forming stations is arranged, wherein said forming stations each have blow molding devices within which the plastics material preforms are formable by application of a flowable medium into the plastics material containers, and the forming stations each have application devices for applying the flowable medium to the plastics material preforms.

Furthermore, the apparatus has a clean room within which the plastics material preforms are expanded and/or can be expanded into the plastics material containers. Furthermore, the apparatus has a feed device to supply plastics material preforms to be formed to the transport device, as well as a discharge device for discharging formed containers from the transport device.

According to the invention, the apparatus has an ejection device for ejecting plastics material preforms or plastics material containers from the transport path, wherein said ejection device is arranged in a region of the discharge device and/or between the discharge device and the feed device and/or in a region of the feed device and/or the ejection device is arranged in a region in which the blow molding devices are at least partially and preferably completely open during working operation.

Preferably, therefore, the aforementioned region between the discharge device and the feed device also includes the respective transfer regions, i.e., in particular the region in which containers (properly) manufactured in a working operation are transferred from the transport carrier and/or the forming stations to the discharge device and/or in particular the region in which plastics material preforms are transferred from the feed device to the transport carrier and/or the forming stations during a working operation.

The apparatus is preferably configured in such a way that the ejection device is arranged in a region in which plastics material containers manufactured in a working operation are transferred from the transport carrier and/or the forming stations to the discharge device.

It is pointed out that the two embodiments described here may also be combined with one another, i.e., the ejection device is both integrated in the clean room as well as arranged between the discharge device and the feed device.

An arrangement between the discharge device of the feed device is understood in particular to mean that the ejection device is arranged along the transport path between the discharge device and the feed device. In particular, in a working operation, it is a region in which already (properly) manufactured containers have been discharged or are being discharged but no new containers or plastics material preforms are being introduced into the blow molding devices.

Particularly preferably, the rotational movement of the transport carrier is an angular range that is greater than 5°, preferably greater than 10°, preferably greater than 20°. Preferably, this is an angular range that is less than 100°,preferably less than 90°, preferably less than 80°, preferably less than 70° and preferably less than 60°.

The ejection device preferably forms a clean room boundary. The ejection device preferably also forms an ejection device or has such an ejection device by which plastics material preforms and/or plastics material containers are transported across a clean room boundary.

The arrangement of the ejection device within the clean room boundary and/or the arrangement within the clean room can ensure that a sterile working operation of the apparatus is not disturbed despite a functioning of this ejection device.

In a preferred embodiment, the apparatus has at least one movable or rotating or rotatable part, in particular the aforementioned transport device or the transport carrier and also a standing or stationary part. The ejection device is preferably arranged in a stationary manner and/or in a stationary part of the apparatus.

The ejection device is preferably suitable and intended for ejecting containers, in particular plastics material preforms as well as blown containers in a running operation. In particular, the ejection device is suitable and intended for ejecting defective plastics material preforms or plastics material containers.

In a further preferred embodiment, the clean room has a toroidal and/or annular shape. Particularly preferably, at least one wall is provided which delimits the clean room. Particularly preferably, at least two walls are provided, wherein a wall and in particular a wall delimiting the clean room is movable relative to the other wall delimiting the clean room.

In a further advantageous embodiment, the apparatus has a sealing device in order to seal the clean room from a non-sterile environment, and preferably the sealing device has at least one circumferential channel which can be filled with a liquid. In this preferred embodiment, a so-called water lock is proposed in order to seal the clean room from the non-sterile environment.

Particularly preferably, the sealing device has a circumferential wall which projects into this circumferential channel, wherein the wall is preferably configured to be rotatable. Particularly preferably, the rotational movement of this wall is coupled to the rotational movement of the transport carrier. This circumferential wall preferably forms a clean room boundary of the clean room.

In a further preferred embodiment, the forming stations each have stretching devices for stretching the plastics material preforms in their longitudinal direction, and these stretching devices preferably each have a stretching rod movable in the longitudinal direction of the plastics material preforms, which stretching rod can be introduced into the plastics material preforms.

In a further advantageous embodiment, the ejection device is suitable and intended for ejecting plastics material preforms or plastics material containers from the clean room. In this case, it is preferably possible for the containers or plastics material preforms to be first removed from the transport path within the clean room and thus for example to come to rest in a specific region of the clean room and then be ejected by the ejection device from the clean room and/or through the sterile room boundary.

In a further preferred embodiment, the apparatus has filter devices and in particular air filter devices which filter the air reaching the plastics material preforms. Preferably, these are so-called HEPA filters.

Particularly preferably, the feed and discharge apparatuses each have transport stars or transport star-wheels in order to supply plastics material preforms or to discharge plastics material containers. In this case, it is possible for a further airlock device to be provided, via which or through which the plastics material preforms are fed to the clean room and/or the transport carrier and/or an airlock device is provided by which (properly formed) plastics material containers are removed from the clean room and/or from the transport carrier or the individual forming stations (during normal working operation).

However, the feed device preferably also transports the plastics material preforms within a clean room and/or under clean room conditions. Particularly preferably, the containers are also transported further within a clean room and, in particular, the discharge device or parts thereof are also located within the or a clean room.

Particularly preferably, the ejection device allows ejection during production, in particular without the apparatus then having to be re-sterilized after the ejection.

Particularly preferably, the apparatus allows at least two independent operating modes or can be operated in at least two independent operating modes, namely on the one hand a working operation in which plastics material preforms are formed into plastics material containers and on the other hand a sterilization operation in which the apparatus is sterilized.

Particularly preferably, the ejection device is suitable and determined to eject both plastics material preforms and plastics material containers, as well as intermediate products produced during the forming process, from the clean room.

As mentioned above, the apparatus particularly preferably has a feed device to supply plastics material preforms to be formed to the transport device, as well as a discharge device for discharging formed containers from the transport device and the ejection device is preferably arranged between the discharge device and the feed device. It is also possible for the ejection device to be arranged geometrically between the discharge device and the feed device, or for components of the ejection device to be arranged geometrically between the discharge device and the feed device.

The arrangement of the ejection device in this angular range furthermore offers the advantage that, in this region, the blow molds are usually opened in a working mode because formed containers have just been removed and no new plastics material preforms have been introduced. This region is therefore particularly preferably for removing plastics material preforms and/or plastics material containers from the transport path.

In a further advantageous embodiment, the ejection device is arranged below the transport path of the plastics material preforms. In this way, a simple ejection process is possible, because the effect of gravity can be utilized to transport the plastics material preforms or plastics material containers to the ejection device. The containers can thus fall out or fall from the transport path in order to reach the ejection device.

The ejection device preferably has an opening which sweeps over an angular range of at least 5°, preferably at least 10°, preferably at least 12° and preferably at least 15° and preferably at least 20°. Particularly preferably, this opening provided by or achievable by the ejection device is dimensioned such that plastics material preforms as well as plastics material containers can fall through this opening.

This ejection device is preferably configured in such a way that the clean room does not have to be re-sterilized once the plastics material preforms or plastics material containers have been ejected.

The ejection device preferably has a closure device and in particular at least one closure flap which closes the aforementioned opening in a working operation of the system. Preferably, this closure flap can be opened towards the outside and/or downward with respect to the clean room.

In a preferred embodiment, the apparatus has a suction device for suctioning off a flowable medium from the clean room, wherein this suction device is arranged in particular in a region of the ejection device. Particularly preferably, this suction device is also arranged between an outlet or between the discharge device and, on the other hand, the inlet, i.e., the aforementioned discharge device, via which the plastics material preforms are guided to the apparatus.

Particularly preferably, the suction device is located between the clean room and a receiving device, which is described in more detail below and serves to receive ejected plastics material preforms or plastics material containers. Particularly preferably, a clean room boundary is also located in this region, because an overpressure preferably prevails in a region above the suction, i.e., the clean room. The suction preferably prevents germs or impurities from entering the clean room.

In a preferred embodiment, the suction device is arranged below the clean room (i.e., closer to the earth's center). A clean room boundary is preferably arranged above the suction device.

As mentioned, the apparatus particularly preferably has a receiving space which serves for receiving the ejected plastics material preforms or plastics material containers or intermediate products. Particularly preferably, this receiving space is arranged outside the clean room. Particularly preferably, this receiving space is located below the clean room and in particular below the ejection device.

Particularly preferably, the ejection device can establish a connection between the clean room and the receiving space. Particularly preferably, this receiving space can be closed completely. Particularly preferably, however, this receiving space also has a door or the like, in particular to be able to ultimately remove ejected containers or plastics material preforms from the clean room.

In a further preferred embodiment, the receiving space can be connected to the clean room and/or the ejection device via an interface.

The above-described suction device preferably has a pump device in order to actively allow a suctioning of a gaseous medium from the clean room.

Particularly preferably, the suction device has at least one tube (at least partially) arranged in the interior of the clean room. This tube is preferably oriented vertically. Particularly preferably, at least two such tubes are provided. These can in particular be arranged laterally next to the ejection device. These tubes particularly preferably end and/or begin within the clean room.

Particularly preferably, the suction device is arranged at least partially below the clean room. Particularly preferably, a clean room boundary is thus located above this suction device.

Particularly preferably, the suction device is configured such that within the clean room the flowable medium is caused to flow in the direction of the ejection device. In this way, a flow is particularly preferably produced vertically downwards. In a working mode, the clean room is particularly preferably exposed to an overpressure with respect to the surroundings. In this way, it can be achieved that gaseous medium cannot get into the clean room.

Preferably, suction from a lower part of the apparatus, in particular a region below the airlock, is not necessary, because this region is not part of the sterile region. The ejection device preferably has airlock doors which, however, can particularly preferably only be opened when further closure devices, as described in more detail below, are folded upward or closed.

In this way, however, these further flaps do not form a clean room boundary, but only serve to maintain an overpressure in the clean room when the door of the receiving space is opened. In this case, a clean room boundary is preferably just above a further closure device (as explained in more detail below) because an overpressure prevails in this upper region relative to the lower region, for example the receiving space for receiving the ejected containers.

This ensures that no germs get into the clean room. As mentioned above, a distinction can be made between a sterilization mode and a production mode. In a sterilization mode, in which no containers are produced, the interior of the clean room is sterilized. For example, H₂O₂ can be introduced. In production mode, in which containers are produced, preferably no hydrogen peroxide or another sterilization agent is introduced into the clean room.

The blowing of the containers is preferably carried out with filtered air and in particular with HEPA-filtered air. In sterilization mode, the airlock door cannot be opened because, otherwise, hydrogen peroxide would reach the outside. The door can only be opened in production mode, because no hydrogen peroxide or another sterilization agent can get out of the clean room during production. However, it is preferably ensured in this case that no contamination of the clean room occurs. This is preferably achieved by an overpressure prevailing in the upper region of the clean room or generally in the clean room.

As mentioned above, the receiving space for receiving ejected plastics material preforms or plastics material containers can particularly preferably be connected to the ejection device. As mentioned above, for example, a further closure device, such as a door or the like, can be provided for this purpose.

In normal operation of the apparatus, said receiving space is preferably separated from the clean room. Said door can be temporarily opened in order to convey plastics material preforms or containers which have already ejected from the clean room and/or the transport path into the receiving space. It is possible in this case for ejected plastics material preforms or plastics material containers to remain in the clean room for a certain time after their ejection from the transport path, for example in the region of the airlock device, to then be ejected from the clean room and preferably into the receiving space.

In a preferred embodiment, the apparatus has a state detection device which is suitable and intended for detecting a faulty forming process and/or a defectively formed container. Such a container can subsequently be ejected. Particularly preferably, such a state detection device can be assigned to each forming station.

Thus, for example, during the expansion process it can be determined that a pressure drop or the like occurs, which indicates to a burst container. In addition, a visual inspection of the containers or plastics material preforms would also be possible, by which an ejection process can then be initiated.

For example, it can be determined that a certain plastics material preform is defective already at the beginning of the blowing process. In this case, a forming of this plastics material preform can be dispensed with, for example, and it can just be transported. The plastics material preform can then be ejected.

Particularly preferably, the apparatus also has an assignment device which assigns a specific forming station to a specific plastics material preform or plastics material container, said forming station possibly causing a fault. In this way, it can be determined that a specific forming station is producing defective plastics material containers, and this forming station can be switched off, as appropriate, for a certain period of time.

In a further advantageous embodiment, the apparatus has a control device which, at least in part, allows the plastics material preforms or plastics material containers to be transported with the transport device between the discharge device and the feed device and/or in an open state of the blow molding device.

As mentioned above, no containers are transported between the discharge device and the feed device in a normal working mode, because already manufactured containers have been dispensed in this region and no new plastics material preforms have been supplied. This means that there would typically be no intact containers in this region. However, when a fault is detected, a control device can cause the corresponding non-intact or defective container to be transported into this region in order to eject it.

Particularly preferably, the transport device has holding devices and in particular controlled holding devices for holding the plastics material preforms or containers. A control device can then cause the holding devices to eject the containers in said region between the discharge device and the feed device.

Particularly preferably, the apparatus has a guiding device in order to open and close the blow molding devices. Particularly preferably, the plastics material preforms or containers are dropped when a blow molding device is opened. In addition, however, an ejection directly on the feed device or the discharge device is also conceivable, for example by a so-called pusher.

In a preferred embodiment, the ejection device is integrated into the clean room as mentioned above and/or the ejection device is integrated into at least one wall that delimits the clean room.

In a further advantageous embodiment, the ejection device allows containers to be ejected from the transport path (but not necessarily from the clean room) during ongoing production.

The present invention is further directed to a method for forming plastics material preforms into plastics material containers, wherein a transport device transports the plastics material preforms to be formed (in particular in a working operation) along a predefined transport path, and wherein the transport device has a rotatable transport carrier on which a plurality of forming stations is arranged, wherein said forming stations each have blow molding devices within which the plastics material preforms are formed by applying a flowable medium to the plastics material containers, and the forming stations each have application devices which apply a flowable, and in particular gaseous, medium to the plastics material preforms, wherein the apparatus further comprises a clean room within which the plastics material preforms are expanded into the plastics material containers.

According to the invention, plastics material preforms or plastics material containers are ejected from the apparatus and in particular from the clean room by an ejection device, wherein the ejection device is integrated into the clean room and/or the ejection device has been or is integrated into at least one wall delimiting the clean room.

In a further method according to the invention for forming plastics material preforms into plastics material containers, a transport device transports the plastics material preforms to be formed along a predefined transport path, wherein the transport device has a rotatable transport carrier on which a plurality of forming stations is arranged and wherein these forming stations each have blow molding devices within which the plastics material preforms are formed by application of a flowable medium into the plastics material containers, and the forming stations each have application devices which apply the flowable medium to the plastics material preforms, wherein the apparatus has a clean room within which the plastics material preforms are expanded with the flowable medium, wherein the plastics material preforms are fed to the transport device by a feed device and the formed plastics material preforms are discharged from the transport device by a discharge device.

According to the invention, plastics material preforms or plastics material containers are ejected by an ejection device from the apparatus and in particular from the clean room, wherein the ejection takes place in a transport direction of the plastics material preforms in a region of the discharge device and/or between the discharge device and the feed device.

An ejection between the discharge device and the feed device is also understood to mean ejecting directly at the discharge device or directly at the feed device, i.e., in those portions in which the containers are transferred from the forming station to the discharge device or in which plastics material preforms are transferred from the feed device to the forming stations.

Preferably, ejection takes place in a region in which the blow molding device have been opened or are opened during working operation.

Particularly preferably, the plastics material preforms are ejected from the transport path during operation.

In a further preferred method, plastics material preforms or plastics material containers are ejected from the clean room.

Further advantages and embodiments can be seen in the accompanying drawings, in which:

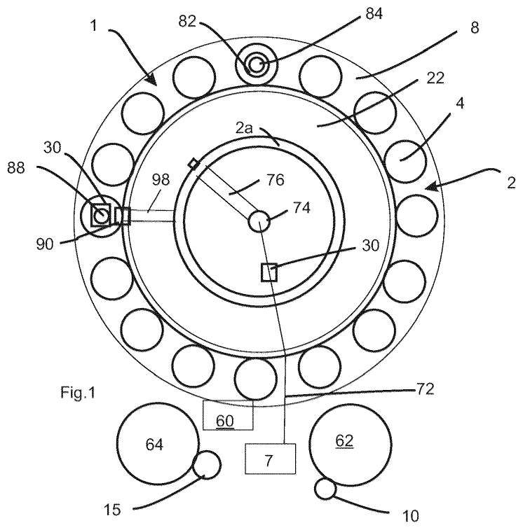

FIG. 1 shows a schematic representation of an apparatus according to the invention;

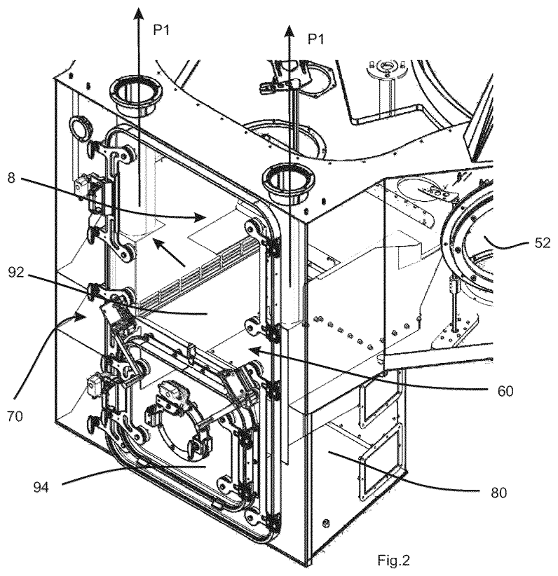

FIG. 2 shows a detailed view of an apparatus according to the invention;

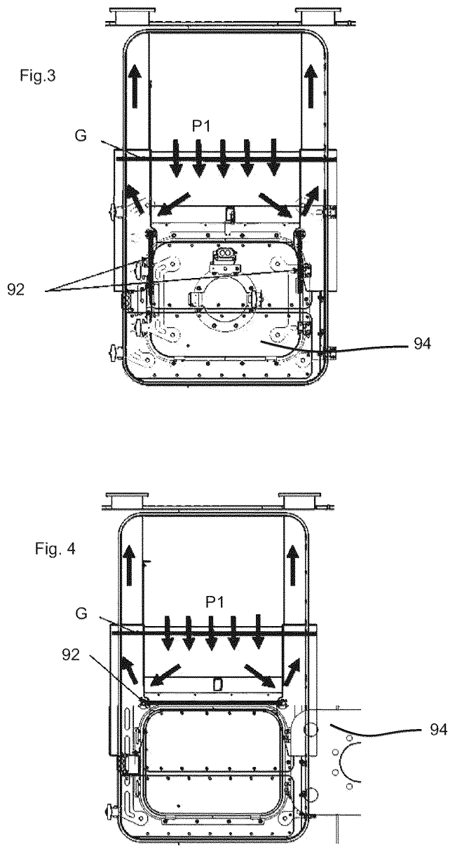

FIG. 3 shows an illustration for suction out of the clean room;

FIG. 4 shows a further illustration for suction out of the clean room.

FIG. 1 shows an apparatus 1 for forming plastics material preforms 10 into plastics material containers 15. This apparatus has a rotatable carrier 22 on which a plurality of forming stations 4 are arranged. These individual forming stations each have blow molds or blow molding devices 82, which form a cavity in their interior for expanding the plastics material preforms.

Reference sign 84 designates an application device which serves for expanding the plastics material preforms 10. This can be a blowing nozzle, for example, which can be applied to a mouth of the plastics material preforms in order to expand the latter. Reference sign 90 designates a valve arrangement, such as a valve block, which preferably has a plurality of valves that control the application of different pressure levels to the plastics material preforms.

In a preferred method, first a pre-blowing pressure P1, then one intermediate blowing pressure Pi that is higher than the pre-blowing pressure, and finally a final blow molding pressure P2 that is higher than the intermediate blowing pressure Pi are applied to the plastics material preforms. After expansion of the plastics material containers, the pressures or compressed air are preferably returned from the container to the individual pressure reservoirs.

Reference sign 88 designates a stretching rod which serves to expand the plastics material preforms in their longitudinal direction. Preferably, all forming stations have such blow molds 82 as well as stretching rods 88. The number of these forming stations is preferably between 2 and 100, preferably between 4 and 60, preferably between 6 and 40.

The plastics material preforms 10 are fed to the apparatus via a first transport device 62 such as, in particular but not exclusively, a transport star-wheel. The plastics material containers 15 are transported away via a second transport device 64. Thus, the transport device 62 is the aforementioned feed device and the transport device 64 is the aforementioned discharge device.

Reference sign 7 designates a pressure supply device, such as a compressor or also a compressed-air connection. The compressed air is conveyed via a connecting line 72 to a rotary distributor 74 and is indicated thereby via a further line 76 to the reservoir 2a, which is preferably an annular channel in this case.

In addition to such annular channel 2a shown, further annular channels are preferably provided, which are, however, concealed by, e.g., lie underneath, the annular channel 2a in the illustration shown in FIG. 1. Reference sign 98 designates a connecting line which delivers the compressed air to a forming station 4 or its valve block 90. Preferably, each of the annular channels is connected to all forming stations via corresponding connecting lines.

Reference sign 8 schematically denotes a clean room, which is preferably annular here and surrounds the transport path of the plastics material preforms 10. Preferably, a (geometric) axis of rotation, with respect to which the transport carrier is rotatable, is arranged outside the clean room 8. Preferably, the clean room is sealed from the non-sterile environment by a sealing device, which preferably has at least two water locks.

The reference sign 60 designates roughly schematically an ejection device. As mentioned above, this is arranged between the discharge device 64 and the feed device 62.

FIG. 2 shows a partial view of an apparatus according to the invention. The clean room 8 can be seen here within which the plastics material preforms are formed into the plastics material containers. The reference sign 60 designates in its entirety an ejection device which serves to eject containers (not shown) from the clean room.

This ejection device in this case has a flap arrangement 92 which is shown here in an open state, i.e., in a state in which plastics material preforms or plastics material containers can be guided out of the clean room into a receiving space 80 (under the action of gravity).

In a closed state of the flap 92, the clean room 8 is delimited from the receiving space 80.

The reference sign 94 designates a closure device and in particular a door by which the receiving space 80 can be opened in order to ultimately remove ejected plastics material preforms or plastics material containers.

Particularly preferably, a locking mechanism is provided which prevents opening of the door 94 when the flap of the ejection device 92 is in the state shown in FIG. 2, i.e., in an open state. In this way, it is possible to prevent the door 94 from being opened, whereby the clean room could be contaminated, as long as a flow connection exists between the clean room 8 and the receiving space 80.

In general, a clean room is understood to mean a room within which there is a higher degree of purity than in a sterile environment. In particular, considerably fewer germs or impurities are present in a clean room than outside the clean room.

The reference sign 52 designates a further airlock device via which plastics material preforms can be supplied here to the clean room.

The reference sign 70 designates a suction device which serves for suctioning a gaseous medium. This suction is carried out via two tubes, as illustrated by the arrows P1.

A suctioning out of the lower part (below the flaps 92) is not necessary, because this region is not a part of the sterile region or clean room. As already shown, the airlock door 94 can only be opened as soon as the flaps 92 are folded upward. However, the flaps 92 do not form a mechanical clean room boundary, but rather serve preferably only for an overpressure in the clean room to be maintained when the doors 94 are open. The clean room border is just above the flap 92, because an overpressure prevails in the upper region relative to the lower region. This ensures that no germs reach the clean room 8.

FIGS. 3 and 4 illustrate the function of this suction.

In the situation shown in FIG. 3, the flaps 92 are open. The suction takes place here along the arrows P1. The reference sign G thus designates a clean room boundary which, however, extends above the flaps 92.

FIG. 4 shows a situation in which the flaps 92 are closed. Here too, the clean room boundary runs above the closed caps 92. In this situation, the door 94 can also be opened, in particular in order to remove containers from the receiving space.

The applicant reserves the right to claim all features disclosed in the application documents as essential to the invention, provided that they are novel over the prior art individually or in combination. It is also pointed out that features which can be advantageous in themselves are also described in the individual figures. A person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. An apparatus for forming plastics material preforms into plastics material containers has a transport device configured to transport the plastics material preforms to be formed along a predefined transport path, wherein the transport device has a rotatable transport carrier on which a plurality of forming stations is arranged, wherein said forming stations each have blow molding devices within which the plastics material preforms can be formed by application of a flowable medium into the plastics material containers, and the forming stations each have application devices configured to apply the flowable medium to the plastics material preforms, and wherein the apparatus has a clean room within which the plastics material preforms are expanded into the plastics material containers,
wherein
the apparatus has an ejection device configured for ejecting plastics material preforms or plastics material containers from the transport path and in particular from the clean room, and in that the ejection device is integrated in the clean room and/or the ejection device is integrated in at least one wall delimiting the clean room.

2. The apparatus according to claim 1.
wherein
the apparatus has a sealing device configured to seal the clean room from an unsterile environment, and this sealing device preferably has at least one circumferential channel that can be filled with a liquid.

3. The apparatus according to claim 1,
wherein
the ejection device is configured for ejecting plastics material preforms or plastics material containers from the clean room.

4. The apparatus according to claim 1,
wherein
the apparatus has a feed device configured for feeding plastics material preforms to be formed to the transport device, and a discharge device configured for discharging formed containers from the transport device, and preferably the ejection device is arranged in a region of the discharge device and/or between the discharge device and the feed device.

5. The apparatus according to claim 1, wherein
the ejection device is arranged below the transport path of the plastics material preforms or plastics material containers.

6. The apparatus according to claim 1, wherein
the apparatus has a suction device configured for suctioning off a flowable medium from the clean room, wherein this suction device is arranged in particular in a region of the ejection device.

7. The apparatus according to claim 1, wherein
the apparatus has a receiving space configured for receiving ejected plastics material preforms or plastics material containers.

8. The apparatus according to claim 1, wherein
the receiving space is configured to be connected to the ejection device by an interface.

9. The apparatus according to claim 1, wherein
the apparatus has a state detection device which configured for detecting a faulty forming process and/or an incorrectly formed container.

10. A method for forming plastics material preforms into plastics mate-rial containers, wherein a transport device transports the plastics material preforms to be formed along a predefined transport path, wherein the transport device has a rotatable transport carrier on which a plurality of forming stations is arranged, wherein said forming stations each have blow molding devices within which the plastics material preforms can be formed by application of a flowable medium into the plastics material containers, and the forming stations each have application devices in order to apply the flowable medium to the plastics material preforms, wherein the apparatus has a clean room within which the plastics material preforms are expanded into the plastics material containers,
wherein
plastics material preforms or plastics material containers are at least temporarily ejected from the apparatus and in particular from the clean room by an ejection apparatus, and in that the ejection device is integrated in the clean room and/or the ejection device is integrated in at least one wall delimiting the clean room.

11. The method according to claim 10,
wherein
plastics material preforms or plastics material containers are ejected from the clean room.

12. The apparatus according to claim 2,
wherein
the apparatus has a feed device configured for feeding plastics material preforms to be formed to the transport device, and a discharge device configured for discharging formed containers from the transport device, and preferably the ejection device is arranged in a region of the discharge device and/or between the discharge device and the feed device.

13. The apparatus according to claim 2, wherein
the ejection device is arranged below the transport path of the plastics material preforms or plastics material containers.

14. The apparatus according to claim 2, wherein
the apparatus has a suction device configured for suctioning off a flowable medium from the clean room, wherein this suction device is arranged in particular in a region of the ejection device.

15. The apparatus according to claim 2, wherein
the apparatus has a receiving space configured for receiving ejected plastics material preforms or plastics material containers.

16. The apparatus according to claim 15, wherein
the receiving space is configured to be connected to the ejection device by an interface.

17. The apparatus according to claim 2, wherein
the apparatus has a state detection device which configured for detecting a faulty forming process and/or an incorrectly formed container.

18. The apparatus according to claim 3,
wherein
the apparatus has a feed device configured for feeding plastics material preforms to be formed to the transport device, and a discharge device configured for discharging formed containers from the transport device, and preferably the ejection device is arranged in a region of the discharge device and/or between the discharge device and the feed device.

19. The apparatus according to claim 3, wherein
the apparatus has a receiving space configured for receiving ejected plastics material preforms or plastics material containers.

20. The apparatus according to claim 19, wherein
the receiving space is configured to be connected to the ejection device by an interface.
